(19) United States
(12) Patent Application Publication
(10) Pub. No.: US 2006/0174770 A1
(43) Pub. Date: Aug. 10, 2006

(54) Coffee outlet of domestic espresso coffee machines

(76) Inventor: Luis Moreno Jordana, Vitoria (ES)

Correspondence Address: LUCAS & MERCANTI, LLP, 475 PARK AVENUE SOUTH, 15TH FLOOR, NEW YORK, NY, 10016, US

(21) Appl. No.: 11/341,552

(22) Filed: Jan. 26, 2006

(30) Foreign Application Priority Data
Feb. 10, 2005 (ES) U 200500300

(51) Int. Cl. A47J 31/00

(52) U.S. Cl. 99/279

(57) ABSTRACT

The coffee output of a domestic espresso coffee machine has a pump which impels pressurized hot water so that it passes through a dose of ground coffee deposited in a filter (1) accommodated in a housing (2), fitted in a filter holder (3) provided with one or more outlet pipes (4) for the infusion of coffee. In the center of the base of this housing (2), is secured a ball (6) valve (5) fitted against a helical compression spring (7) such that the ball (6) and spring (7) are thrust upward in a chamber (11) of the valve (5). This chamber (11) communicates with the interior of the housing (2) and with the cavity in the filter holder (3). Ball (6) is installed between the lower side of the upper aperture (9) and the upper end of the spring (7). Spring (7) is installed between the ball (6) and a lower aperture (10) having a conical shape narrowing in the downward direction and obtained by pressure forming.

### FIELD OF THE INVENTION

This invention relates to domestic espresso coffee machines which comprise a pump which impels pressurised hot water so that it passes though a dose of ground coffee or a single-dose pod deposited in a filter which is accommodated in a housing, which in turn is fitted in a filter holder which is provided with one or more outlet pipes for the infusion of coffee produced.

In particular, the invention relates to some improvements which concern the device for production of foamed coffee (café crème) and to a device which is designed such that, when the coffee machine serves coffee to two cups simultaneously, the quantity served in each cup is the same.

### PRIOR STATE OF THE ART

The foamed coffee is produced by means of an emulsion of the coffee infusion and air, which is obtained by forcing the passage of coffee through fine ducts provided in the housing, thus increasing the pressure; after passage beyond these fine ducts there occurs expansion or a decrease in this pressure, which gives rise to division into fine droplets of infusion of coffee which is close to a state of spraying, in which the mixing with air is assisted.

Spanish Utility Model no. U-200103033 is known in this field, which claims a device which is designed to permit gradual regulation of the quantity of foamed coffee; this device consists of a body which is connected at its base to the housing, and forms an inner chamber into which there is screwed a vertical screw which has an inner aperture, and which in its interior incorporates a helical compression spring which thrusts a ball against an upper aperture in this body, which communicates with the interior of the housing; by means of the greater or lesser degree of screwing of the screw into the body, a smaller or larger amount respectively of foamed coffee will be obtained, because greater or lesser pressure will be necessary to contract the spring and permit output of the infusion of coffee. This solution works well, but over a period of time the screw may become loosened and the quantity of foamed coffee obtained will become gradually less.

Furthermore, this type of coffee machine suffers from a disadvantage in general. When the filter holder has two pipes, and two cups must be served from them simultaneously, the filling is frequently unequal in the two of them, and this is also an uncontrolled phenomenon, because it does not always occur, or does not occur in the same manner; sometimes the filling is the same in both cups and on other occasions it is not, and in this last case the difference in filling is variable. It appears that, like any liquid, the coffee tends to flow along one specific path partially to the detriment of the other, either because of the effects of surface tension, defects of horizontality, dirtiness or irregularities in the base of the filter holder, because of how the jet of coffee emerges towards this base of the filter holders, because of occasional vibrations in the surroundings of the coffee machine, or for other reasons.

### EXPLANATION AND ADVANTAGES OF THE INVENTION

In view of this situation, one of the improvements provided by the present invention consists in the fact that the centre of the base of the said housing there is secured a ball valve which is fitted against a helical compression spring such that the ball and spring are thrust in a chamber of the valve, wherein, by means of respective upper and lower apertures, this chamber communicates with the interior of the said housing and with the cavity in the said filter holder, which ball is installed between the lower side of the said upper aperture and the upper end of the said spring, and which spring is installed between the said ball and a said lower aperture which has a conical shape which narrows in the downward direction and is obtained by pressure forming. In this solution proposed, there is no screwing of parts, since there exists only the valve body, wherein the sub-assembly of the ball and spring is installed in a manner which is confined and cannot be dismantled, such that the operative behaviour is always the same, and therefore there will always be an equal quantity of foamed coffee in the coffee infusion obtained; varying the resilient characteristics of the spring provides variation of the quantity of foamed coffee for a specific working pressure of the pump, and vice versa. As well as this functional advantage obtained, there are those derived from the use of fewer parts, and furthermore the appearance of the new device is improved. This can be appreciated when the coffee machine is in standby without the filter holder fitted. This detail is important taking into consideration the fact that domestic rather than industrial coffee machines are involved.

Another improvement according to the invention consists in the fact that this filter holder has two pipes with diameters which are the same as one another, such that the flow drained by the set of two is advantageously less than the flow supplied by the pump, whereas between these two pipes the filter holder has a curved convex base which has its cusp aligned vertically with the axis of the liquid flow of coffee infusion which is supplied by the said valve, whilst these pipes have a width which is suitable for assuring a laminar flow of this liquid produced. The functionality of this solution consists in the fact that since the pipes cannot discharge the entire flow they receive from the valve, damming occurs, the level of which subsequently rises above the cusp of the curved convex base of the filter holder; consequently, from this moment onwards, the coffee is discharged through the pipes by gravity, and in view of the designed width of these pipes, the flow is highly laminar, which ensures that the flow through both of the pipes is the same (the two cups are filled equally with coffee) and the quantity of foamed coffee produced is maintained in its course through these pipes. In addition, this device is compatible with the use of a housing for the dose of ground coffee or of a single-dose pod, suitable for a single cup or for two cups of coffee, still using the filter holder with two pipes.

### DRAWINGS AND REFERENCES

In order to understand better the nature of the present invention, the attached drawings represent a preferred industrial embodiment, which is in the nature of a purely illustrative and non-limiting example.

FIG. 1 is a lateral view of a filter holder 3 provided with the improvements proposed and shown according to the section I-I in FIG. 2.

FIG. 2 is a plan view from above of the filter holder 3 according to FIG. 1.

FIG. 3 is the view according to section III-III indicated in FIG. 2, and shows a housing 2 for two doses of ground coffee (for two cups).

FIG. 4 is like FIG. 3, but relates to a housing 2 for the dose of a single cup of coffee served.

FIG. 5 is an exploded view showing the sub-assembly formed by the valve 5, the ball 6 and the spring 7, before producing the pressure adjustment of the tip of the valve 5 and the upper thrusting of this valve 5 relative to the housing 2.

FIG. 6 is an enlargement of the detail VI circled in FIG. 1.

FIG. 7 is an enlarged view of the detail VII shown in FIG. 3.

These figures contain the following references:
1. Filter
2. Housing
3. Filter holder
4. Filter holder pipes (3)
5. Valve
6. Ball
7. Helical compression spring
8. Filter holder curved convex base (3)
9. Upper valve aperture (5)
10. Lower valve aperture (5)
11. Valve chamber (5)

### DESCRIPTION OF A PREFERRED EMBODIMENT

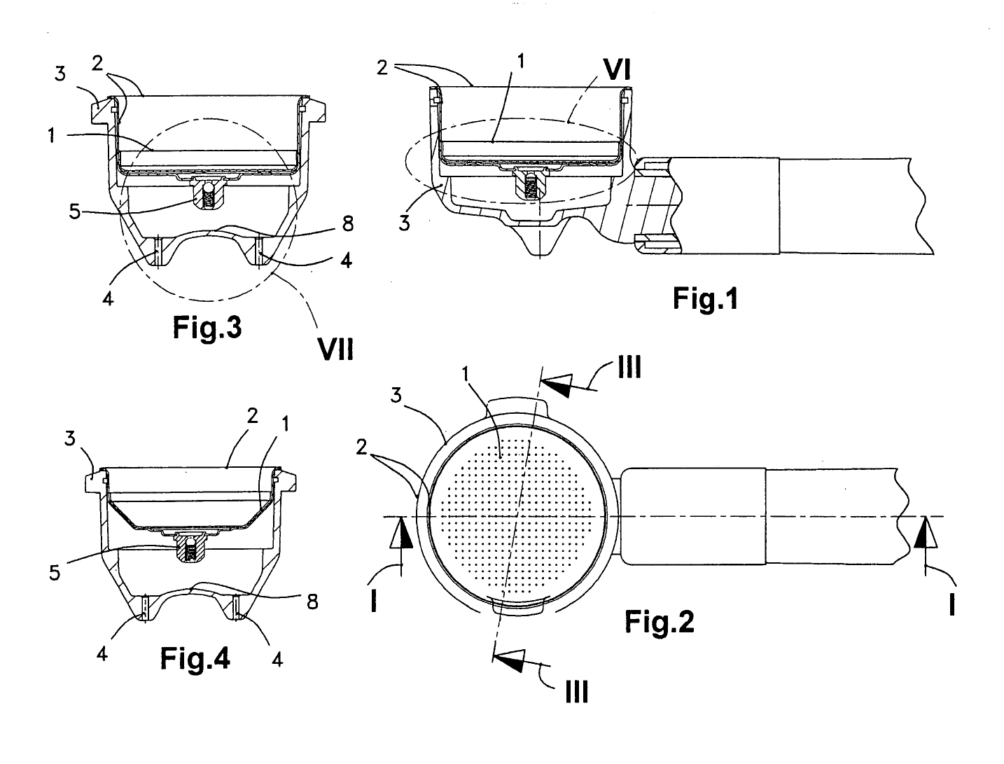

With reference to the aforementioned drawings and references, the attached figures illustrate the preferred embodiment of the improvements proposed by the invention, which relate to espresso coffee machines comprising (FIGS. 1 to 4) a pump which impels pressurised hot water so that it passes though a dose of ground coffee deposited in a filter 1 which is accommodated in a housing 2, which in turn is fitted in a filter holder 3 which is provided with one or more outlet pipes 4, (preferably two) for the infusion of coffee produced.

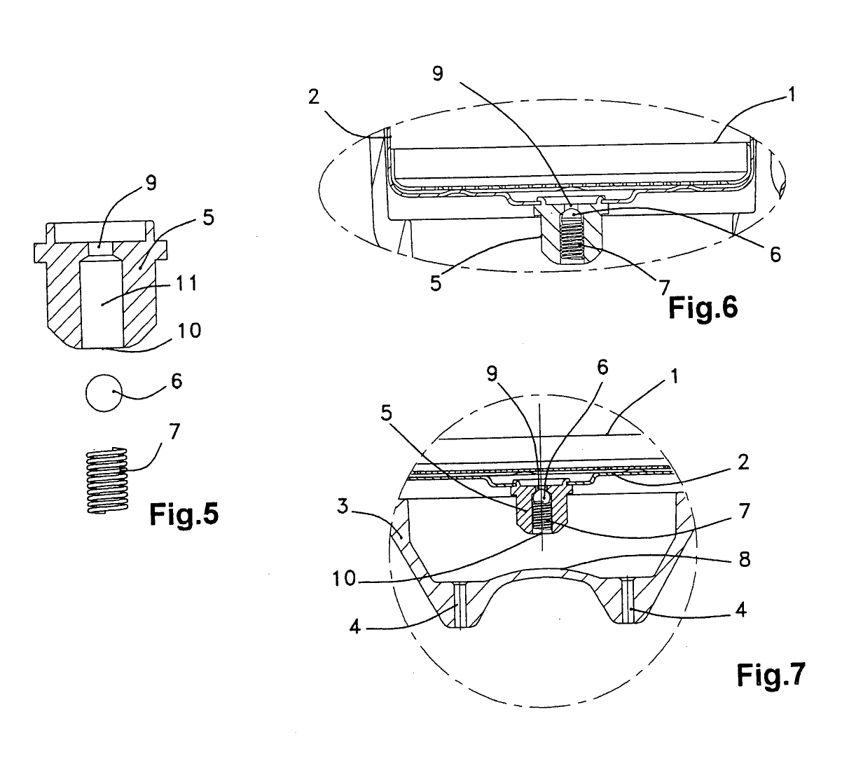

One of these improvements is illustrated clearly by means of FIGS. 5 and 6. This consists in the fact that, in the centre of the base of this housing 2, there is secured a ball 6 valve 5 which is fitted against a helical compression spring 7 such that the ball 6 and spring 7 are thrust in a chamber 11 of the valve 5, wherein, by means of respective upper 9 and lower 10 apertures, this chamber 11 communicates with the interior of the said housing 2 and with the cavity in the said filter holder 3, which ball 6 is installed between the lower side of the said upper aperture 9 and the upper end of the said spring 7, and which spring 7 is installed between the said ball 6 and a said lower aperture 10 which has a conical shape which narrows in the downward direction and is obtained by pressure forming. FIG. 5 shows the components which constitute these improvements, before they are assembled in an inseparable manner by means of adjustment of the tip of the valve 5 which contains permanently in its interior the ball 6 and the spring 7, thus providing the definitive operative configuration which is installed in the base of the housing 2, as shown in FIG. 6.

Another improvement proposed by the invention is that shown in greater detail in FIG. 7, wherein it can be seen that the said filter holder 3 is provided with two pipes 4 with diameters which are the same as one another, such that the flow drained by the set of two is advantageously less than the flow supplied by the pump, whereas between these two pipes 4 the filter holder 3 has a curved convex base 8 which has its cusp aligned vertically with the axis of the liquid flow of coffee infusion which is supplied by the said valve 5, whilst these pipes 4 have a width which is suitable for assuring a laminar flow of this liquid produced. By means of this composition, the flow of liquid provided by the valve 5 falls onto the curved convex base 8 of the filter holder 3 with a flow rate greater than that which can be drained by the pipes 4, thus forming a well, the level of which rises above the upper level of the curved convex base 8, and the flow through the pipes 4 begins to occur by gravity in a laminar manner, and with an equal flow for each pipe; thus, the quantity of coffee served in each cup is the same. The same filter holder 3 with two pipes 4 can be used equally well for a single dose of ground coffee (or single-dose pod) (FIG. 4) which is served in a single cup via both pipes 4, or it can be served into two cups.

1. Improvements to the coffee output of domestic espresso coffee machines, comprising a pump which impels pressurised hot water so that it passes though a dose of ground coffee (or a single-dose pod) deposited in a filter (1) which is accommodated in a housing (2), which in turn is fitted in a filter holder (3) which is provided with one or more outlet pipes (4) for the infusion of coffee produced, characterised in that, in the centre of the base of this housing (2), there is secured a ball (6) valve (5) which is fitted against a helical compression spring (7) such that the ball (6) and spring (7) are thrust in a chamber (11) of the valve (5), wherein, by means of respective upper (9) and lower (10) apertures, this chamber (11) communicates with the interior of the said housing (2) and with the cavity in the said filter holder (3), which ball (6) is installed between the lower side of the said upper aperture (9) and the upper end of the said spring (7), and which spring (7) is installed between the said ball (6) and a said lower aperture (10) which has a conical shape which narrows in the downward direction and is obtained by pressure forming.

2. Improvements to the coffee output of domestic espresso coffee machines, according to claim 1, characterised in that the said filter holder (3) is provided with two pipes (4) with diameters which are the same as one another, such that the flow drained by the set of two is advantageously less than the flow supplied by the pump, whereas between these two pipes (4) the filter holder (3) has a curved convex base (8) which has its cusp aligned vertically with the axis of the liquid flow of coffee infusion which is supplied by the said valve (5), whilst these pipes (4) have a width which is suitable for assuring a laminar flow of this liquid produced.
